(19) United States
(12) Patent Application Publication
(10) Pub. No.: US 2017/0060993 A1
(43) Pub. Date: Mar. 2, 2017

(54) Creating a Training Data Set Based on Unlabeled Textual Data

(71) Applicant: Skytree, Inc., San Jose, CA (US)

(72) Inventors: Nick Pendar, San Ramon, CA (US); Zhuang Wang, San Carlos, CA (US)

(21) Appl. No.: 15/253,249

(22) Filed: Aug. 31, 2016

Related U.S. Application Data
(60) Provisional application No. 62/213,091, filed on Sep. 1, 2015.

(51) Int. Cl. G06F 17/30; G06N 99/00

(52) U.S. Cl. CPC G06F 17/30675; G06F 17/30705; G06N 99/005

(57) ABSTRACT

A system and method are disclosed for obtaining a plurality of unlabeled text documents; obtaining an initial concept; obtaining keywords from a knowledge source based on the initial concept; scoring the plurality of unlabeled documents based at least in part on the initial keywords; determining a categorization of the documents based on the scores; performing a first feature selection and creating a first vector space representation of each document in a first category and a second category, the first and second categories based on the scores, the first vector space representation serving as one or more labels for an associated unlabeled textual document; and generating the training set including a subset of the obtained unlabeled textual documents, the subset of the obtained unlabeled documents including a documents belonging to the first category and documents belonging to the second category.

### CROSS REFERENCE TO RELATED APPLICATIONS

The present application claims priority, under 35 U.S.C. §119, of U.S. Provisional Patent Application No. 62/213,091, filed Sep. 1, 2015 and entitled “Creating a Training Data Set Based on Unlabeled Textual Data,” which is incorporated by reference in its entirety.

### BACKGROUND

1. Field of the Invention

The present disclosure is related to machine learning. More particularly, the present invention relates to systems and methods for creating a training data set based on unlabeled textual data when a training set is not present.

2. Description of Related Art

Machine Learning, for example, supervised machine learning requires training data. However, good training data is hard to find and may be subject to the “cold start” problem where the system cannot draw inferences or make predictions about which the system has not yet gathered sufficient information. Present methods and systems for creating training sets based on textual data, particularly unlabeled documents, have drawbacks. For example, human annotation may be accurate, but is expensive and does not scale; hashtags are abundant but extremely noisy; unambiguous keywords are accurate but difficult to curate and may have low recall; a comprehensive keyword set may provide large coverage, but is noisy.

Thus, there is a need for a system and method that creates a training set of data based on unlabeled textual data and addresses one or more of the aforementioned drawbacks in existing methods and systems.

### SUMMARY

According to one innovative aspect of the disclosure, a method for creating a training set of data includes obtaining a plurality of unlabeled text documents; obtaining an initial concept; obtaining keywords from a knowledge source based on the initial concept; scoring the plurality of unlabeled documents based at least in part on the initial keywords; determining a categorization of the documents based on the scores; performing a first feature selection and creating a first vector space representation of each document in a first category and a second category associated with the first feature selection, the first and second categories based on the scores, the first vector space representation serving as one or more labels for an associated unlabeled textual document; and generating the training set including a subset of the obtained unlabeled textual documents, the subset of the obtained unlabeled documents including a documents belonging to the first category based on the scores and documents belonging to the second category based on the scores, the training set including the first vector space representations for the subset of the obtained unlabeled documents belonging to the first category based on the scores and the second category based on the scores, the first vector space representations serving as one or more labels of the subset of the obtained unlabeled documents belonging to the first category and the second category.

Other aspects include corresponding methods, systems, apparatus, and computer program products for these and other innovative features.

For instance, the operations further include using the vector space representation of each document in the one or more categories as labels for the unlabeled textual documents; and generating, using the vector space representation of each document in the first and second categories as labels for the unlabeled textual data, a model using a supervised machine learning method. For instance, the features include the model using the supervised machine learning method is a classifier. For instance, the features include generating the model using the supervised machine learning method includes training one or more binary classifiers.

For instance, the operations further include performing a second feature selection and creating a second vector space representation of each document in a third category and a fourth category associated with the second feature selection, the third and fourth categories based on the scores, the second vector space representation serving as one or more additional labels for an associated unlabeled textual document; using the first and second vector space representations of each document in the one or more categories as labels for the unlabeled textual documents; and generating, using the vector space representation of each document in the first, second, third and fourth categories as labels for the unlabeled textual data, a model using a multiclass classifier on a union of feature sets from the first and second feature selections.

For instance, the operations further include determining the knowledge source based on the initial concept. For instance, the features include categorization of documents based on score categorizes a document with a score satisfying a first threshold as positive and categorizes the document as negative when the score of the document does not satisfy the first threshold. For instance, the features include categorization of documents based on score categorizes a document with a score satisfying a first threshold as positive and categorizes the document as negative when the score of the document satisfies a second threshold. For instance, the features include that the scores are based in part on the knowledge source from which a first, initial keyword was obtained and based on weights associated with the initial key words.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for creating a set of training data according to one implementation.

FIG. 2 is a block diagram of an example machine learning server in accordance with one implementation.

FIG. 3 depicts an example illustration of a method for creating training data in accordance with one implementation.

### DETAILED DESCRIPTION

The present disclosure overcomes the deficiencies of the prior art by providing a system and method for creating a training set of data. In some implementations, the present disclosure overcomes the deficiencies of the prior art by providing a system and method for creating a training set of labeled textual data from unlabeled textual data and which may be used to train a high-precision classifier.

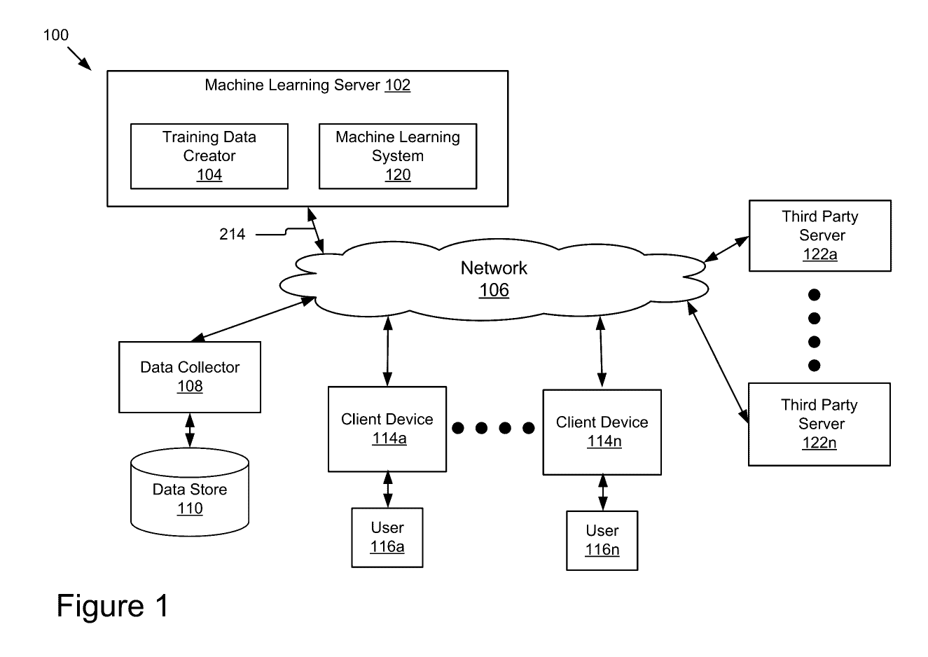

FIG. 1 shows an example system 100 for creating training data based on textual data according to one implementation. In the depicted implementation, the system 100 includes a machine learning server 102, a network 106, a data collector 108 and associated data store 110, client devices 114a . . . 114n (also referred to herein independently or collectively as 114), and third party servers 122a . . . 122n (also referred to herein independently or collectively as 122).

The machine learning server 102 is coupled to the network 106 for communication with the other components of the system 100, such as the services/servers including the data collector 108, and the third party servers 122. The machine learning server 102 processes the information received from the plurality of resources or devices 108, 122, and 114 to create a set of training data and, in some implementations, train a model using the created training data. The machine learning server 102 includes a training data creator 104 for creating training data based on textual data and a machine learning system 120 for using the training data.

The servers 102, 108 and 122 may each include one or more computing devices having data processing, storing, and communication capabilities. For example, the servers 102, 108 and 122 may each include one or more hardware servers, server arrays, storage devices and/or systems, etc. In some implementations, the servers 102, 108 and 122 may each include one or more virtual servers, which operate in a host server environment and access the physical hardware of the host server including, for example, a processor, memory, storage, network interfaces, etc., via an abstraction layer (e.g., a virtual machine manager). In some implementations, one or more of the servers 102, 108 and 122 may include a web server (not shown) for processing content requests, such as an HTTP server, a REST (representational state transfer) service, or other server type, having structure and/or functionality for satisfying content requests and receiving content from one or more computing devices that are coupled to the network 106 (e.g., the machine learning server 102, the data collector 108, the client device 114, etc.).

The third party servers 122 may be associated with one or more entities that obtain or maintain textual data. In one implementation, the textual data maintained is unlabeled textual data. Examples of unlabeled textual data include, but are not limited to, microblogs (e.g. Tweets), large knowledge base libraries, webpages, blogs, eDiscovery, etc. It should be recognized that the preceding are merely examples of entities which may receive textual data and that others are within the scope of this disclosure.

The data collector 108 is a server or service which collects textual data from other servers, such as the third party servers 122, and/or by receiving textual data from the client devices 114 themselves. The data collector 108 may be a first party server or a third-party server (i.e., a server associated with a separate company or service provider), which mines data, crawls the Internet, and/or obtains textual data from other servers. For example, the data collector 108 may collect textual data from other servers and then provide it as a service.

The data store 110 is coupled to the data collector 108 and comprises a non-volatile memory device or similar permanent storage device and media and, in some implementations, is accessible by the machine learning server 102.

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another implementation, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, WAP, email, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the machine learning server 102 and/or other components (e.g., 108 or 122) of the system 100 may aggregate data from and create training data from a multiplicity of users 116a . . . 116n on a multiplicity of client devices 114a . . . 114n. In some implementations, a single user may use more than one client device 114, which the machine learning server 102 (and/or other components of the system 100) may track. For example, the third party server 122 may track the textual data of a user across multiple client devices 114.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different implementations of the system 100 that include one or more servers 102, 108 and 122, the network 106, and one or more client devices 114. In a first example, the one or more servers 102, 108 and 122 may each be dedicated devices or machines coupled for communication with each other by the network 106. In a second example, any one or more of the servers 102, 108 and 122 may each be dedicated devices or machines coupled for communication with each other by the network 106 or may be combined as one or more devices configured for communication with each other via the network 106. For example, the machine learning server 102 and a third party server 122 may be included in the same server. In a third example, any one or more of one or more servers 102, 108 and 122 may be operable on a cluster of computing cores in the cloud and configured for communication with each other. In a fourth example, any one or more of one or more servers 102, 108 and 122 may be virtual machines operating on computing resources distributed over the Internet.

While the system 100 shows only one device for each of 102, 108, 122a, 122n, it should be understood that there could be any number of devices. Moreover, it should be understood that some or all of the elements of the system 100 could be distributed and operate in the cloud using the same or different processors or cores, or multiple cores allocated for use on a dynamic as-needed basis.

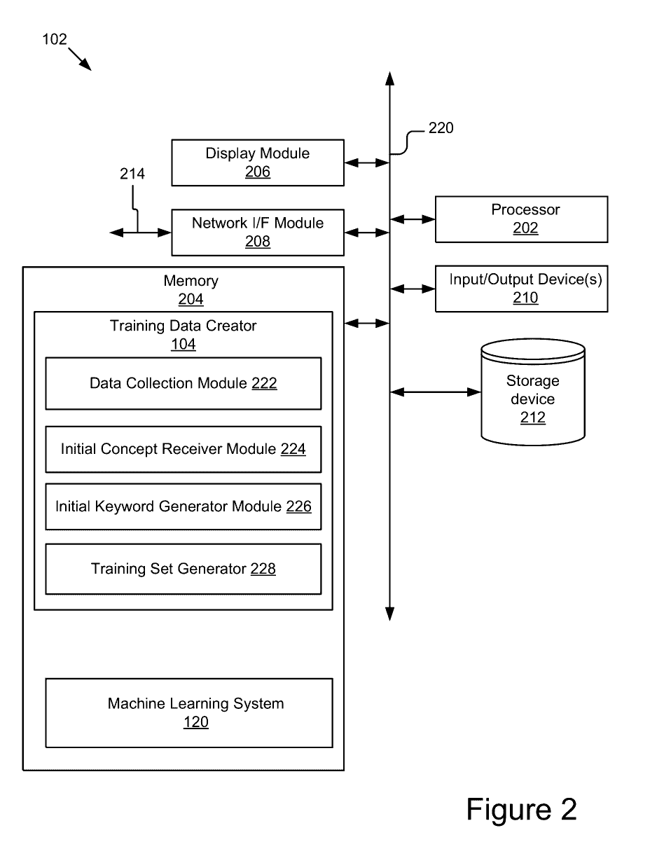

Referring now to FIG. 2, an implementation of a machine learning server 102 is described in more detail. The machine learning server 102 comprises a processor 202, a memory 204, a display module 206, a network I/F module 208, an input/output device 210 and a storage device 212 coupled for communication with each other via a bus 220. The machine learning server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the machine learning server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. In some implementations, the processor(s) 202 may be coupled to the memory 204 via the bus 220 to access data and instructions therefrom and store data therein. The bus 220 may couple the processor 202 to the other components of the machine learning server 102 including, for example, the display module 206, the network I/F module 208, the input/output device(s) 210, and the storage device 212.

The memory 204 may store and provide access to data to the other components of the machine learning server 102. In some implementations, the memory 204 may store instructions and/or data that may be executed by the processor 202. For example, as depicted in FIG. 2, the memory 204 may store the machine learning system 120 (as shown in FIG. 1), the training data creator 104, and their respective components, depending on the configuration. The memory 204 is also capable of storing other instructions and data, including, for example, an operating system, hardware drivers, other software applications, databases, etc.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In one implementation, the memory 204 also includes a non-volatile memory such as a hard disk drive or flash drive for storing information on a more permanent basis. The memory 204 is coupled by the bus 220 for communication with the other components of the machine learning server 102. It should be understood that the memory 204 may be a single device or may include multiple types of devices and configurations.

The display module 206 may include software and routines for sending processed data, analytics, or recommendations for display to a client device 114, for example, to allow an administrator to interact with the machine learning server 102. In some implementations, the display module may include hardware, such as a graphics processor, for rendering user interfaces.

The network I/F module 208 may be coupled to the network 106 (e.g., via signal line 214) and the bus 220. The network I/F module 208 links the processor 202 to the network 106 and other processing systems. The network I/F module 208 also provides other conventional connections to the network 106 for distribution of files using standard network protocols such as TCP/IP, HTTP, HTTPS and SMTP as will be understood to those skilled in the art. In an alternate implementation, the network I/F module 208 is coupled to the network 106 by a wireless connection and the network I/F module 208 includes a transceiver for sending and receiving data. In such an alternate implementation, the network I/F module 208 includes a Wi-Fi transceiver for wireless communication with an access point. In another alternate implementation, network I/F module 208 includes a Bluetooth® transceiver for wireless communication with other devices. In yet another implementation, the network I/F module 208 includes a cellular communications transceiver for sending and receiving data over a cellular communications network such as via short messaging service (SMS), multimedia messaging service (MIMS), hypertext transfer protocol (HTTP), direct data connection, WAP, email, etc. In still another implementation, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the machine learning server 102 and can be coupled to the system either directly or through intervening I/O controllers. The I/O devices 210 may include a keyboard, mouse, camera, stylus, touch screen, display device to display electronic images, printer, speakers, etc. An input device may be any device or mechanism of providing or modifying instructions to the machine learning server 102. An output device may be any device or mechanism of outputting information from the machine learning server 102, for example, it may indicate status of the machine learning server 102 such as: whether it has power and is operational, has network connectivity, or is processing transactions.

The storage device 212 is an information source for storing and providing access to textual data, such as unlabeled documents and/or training data as described herein. The data stored by the storage device 212 may be organized and queried using various criteria including any type of data stored by it. The storage device 212 may include data tables, databases, or other organized collections of data. The storage device 212 may be included in the machine learning server 102 or in another computing system and/or storage system distinct from but coupled to or accessible by the machine learning server 102. The storage device 212 can include one or more non-transitory computer-readable mediums for storing data. In some implementations, the storage device 212 may be incorporated with the memory 204 or may be distinct therefrom. In some implementations, the storage device 212 may store data associated with a database management system (DBMS) operable on the machine learning server 102. For example, the DBMS could include a structured query language (SQL) DBMS, a NoSQL DBMS, various combinations thereof, etc. In some instances, the DBMS may store data in multi-dimensional tables comprised of rows and columns, and manipulate, e.g., insert, query, update and/or delete, rows of data using programmatic operations.

The bus 220 represents a shared bus for communicating information and data throughout the machine learning server 102. The bus 220 can include a communication bus for transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the server 102 (operating systems, device drivers, etc.), and any of the components of the training data creator 104 may cooperate and communicate via a communication mechanism included in or implemented in association with the bus 220. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

In one implementation, the machine learning system 120 includes a computer program that takes as input the training data created by 104. Depending on the implementation, the machine learning system 120 may provide different features and functionality (e.g. by applying different machine learning methods in different implementations).

As depicted in FIG. 2, the training data creator 104 may include and may signal the following to perform their functions: a data collection module 222 that receives textual data (e.g. unlabeled textual data) from one or more of the network I/F module 208, a storage device 212 and input/output device 210 and passes it to the training set generator 228, an initial concept receiver module 224 that receives an initial concept, and passes the initial concept to the initial keyword generator module 226, an initial keyword generator module 226 that determines one or more knowledge sources and identifies a set of initial keywords using the one or more knowledge sources, and a training set generator 228 for searching, scoring, splitting and extracting Machine Learning features from the data. These components 222, 224, 226, 228, and/or components thereof, may be communicatively coupled by the bus 220 and/or the processor 202 to one another and/or the other components 206, 208, 210, and 212 of the machine learning server 102. In some implementations, the components 222, 224, 226, 228 may include computer logic (e.g., software logic, hardware logic, etc.) executable by the processor 202 to provide their actions and/or functionality. In any of the foregoing implementations, these components 222, 224, 226, 228 may be adapted for cooperation and communication with the processor 202 and the other components of the machine learning server 102.

The data collection module 222 includes computer logic executable by the processor 202 to collect or aggregate textual data (e.g. unlabeled documents such as Tweets) from one or more information sources, such as computing devices and/or non-transitory storage media (e.g., databases, servers, etc.) configured to receive and satisfy data requests. In some implementations, the data collection module 222 obtains information from one or more of a third party server 122, the data collector 108, the client device 114, and other providers. For example, the data collection module 222 obtains textual data by sending a request to one or more of the server 108, 122 via the network I/F module 208 and network 106.

The data collection module 222 is coupled to the storage device 212 to store, retrieve, and/or manipulate data stored therein and may be coupled to the initial concept receiver module 224, the initial keyword generator module 226, the training set generator 228, and/or other components of the training data creator 104 to exchange information therewith. For example, the data collection module 222 may obtain, store, and/or manipulate textual data aggregated by it in the storage device 212, and/or may provide the data aggregated and/or processed by it to one or more of the initial concept receiver module 224, the initial keyword generator module 226 and the training set generator 228 (e.g., preemptively or responsive to a procedure call, etc.).

The data collection module 222 collects data and may perform other operations described throughout this specification. It should be understood that other configurations are possible and that the data collection module 222 may perform operations of the other components of the system 100 or that other components of the system may perform operations described as being performed by the data collection module 222.

The initial concept receiver module 224 includes computer logic executable by the processor 202 to receive an initial concept (e.g. basketball). Depending on the implementation, the initial concept may be from a user (e.g. an administrator who seeks to generate a set of training data to seed a classifier and avoid a “cold start” problem) or may be received automatically (e.g. based on a determination of the initial concept using an algorithm or data lookup).

For clarity and convenience, the present disclosure will discuss an example implementation and example application of the invention in which the initial concept is “basketball” and the textual data is a large number of unlabeled documents in the form of “Tweets.” However, it should be recognized that this is merely an example to help describe features and functionality of the invention and is not limiting. It should be recognized that other initial concepts and forms or unlabeled documents are contemplated and within the scope of this disclosure.

The initial keyword generator module 226 may include computer logic executable by the processor 202 to generate one or more initial keywords.

In one implementation, the initial keyword generator 226 determines one or more knowledge sources and collects keywords from the knowledge source based on the initial concept. In some implementations, one or more of the knowledge source and number of knowledge sources may vary depending on the initial concept. For example, in one implementation, a determination is made as to whether the initial concept is associated with a specialized knowledge source (i.e. a knowledge source that specializes on a particular concept or set of concepts). Examples of specialized knowledge sources may include, but are not limited to, websites, blogs, forums, etc. that are directed to a particular topic or set of topics such as sports, home improvement, travel, etc. When the initial concept (e.g. basketball) is associated with a specialized knowledge source (e.g. ESPN which is directed to sports including basketball), the initial keyword generator 226 generates keywords from the specialized knowledge source. When the initial concept is not associated with a specialized knowledge source, the initial keyword generator 226 generates keywords from a general knowledge source (i.e. a knowledge source that covers many and diverse topics, for example, an online encyclopedia such as Wikipedia).

In one implementation, one or more knowledge sources are determined automatically by the initial keyword generator module 226, e.g., based on the initial concept “basketball,” the initial keyword generator module 226 determines that ESPN's website is a knowledge source. In one implementation, one or more knowledge sources are determined by the initial keyword generator module 226 based on user input, e.g., based on the initial concept “basketball,” a user selects the NBA's website and ESPN's website as a knowledge sources. In one implementation, one or more knowledge sources are determined by the initial keyword generator module 226 by default, e.g., Wikipedia is included as a knowledge source by default.

In one implementation, the one or more knowledge sources may be weighted. For example, the NBA's website may be more heavily weighted than ESPN's website, which is more heavily weighted than Wikipedia. In one implementation, the weighting of a source may affect a weighting associated with an initial keyword collected by the initial keyword generator module 226 from that source.

The initial keyword generator module 226 collects keywords from the one or more knowledge sources, for example, by crawling the one or more knowledge sources. For example, the initial keyword generator module 226 begins crawling the “Basketball” article on Wikipedia, then crawls articles that the “Basketball” article links to, then crawls the articles that those articles link to, and so on. In one implementation, the depth of the described crawling may be limited. For example, the limitation may be user defined, determined based on machine learning or hard coded depending on the implementation. For example, in one implementation, the depth is limited to 6. In one implementation, the keywords collected from the various articles are the titles of articles that the present article links to.

In one implementation, the one or more initial keywords may be weighted. Examples of weighting include, but are not limited to, number of occurrences (e.g. did multiple articles link to an article with keyword “X” and/or how many times was the keyword “X” used in one or more of the articles), the depth at which the keyword was collected also referred to as the “degrees of separation” (e.g., was the keyword obtained from the initial “Basketball” article or from an article that links to an article that the “Basketball” article links to), the source (e.g. Wikipedia initial keywords may not be weighted as highly as ESPN initial keywords), the number of sources from which the keyword was collected (e.g. if the same keyword is collected from both Wikipedia and ESPN's website it may be weighted differently than a keyword collected from either website alone), etc.

The initial keyword generator module 226 may store the initial keywords for access by the training set generator 228 and/or may pass the initial keywords to the training set generator 228.

The training set generator 228 may include computer logic executable by the processor 202 to generate a set of training data based on textual data using the initial keywords.

The training set generator 228 obtains the initial keywords from the initial keyword generator and obtains the textual data (e.g. unlabeled data such as 100,000 Tweets) from the data collection module and searches the textual data for the initial keywords. Based on the search of the keywords, the training set generator 228 determines a score for each document (e.g. a score for each Tweet). The number of scoring algorithms used and the specific scoring algorithm(s) used may vary based on the implementation. For example, in one implementation, when an initial keyword appears in a hashtag, the score may be adjusted up or down accordingly. In another example, when an initial keyword appears multiple times in the Tweet, the score may be adjusted up or down accordingly. In yet another example, when an initial keyword with a greater weight (e.g. because of its source) appears in a document, the score may be adjusted up or down by a greater degree than when a keyword with a lesser weight appears in the document.

The training set generator 228 then applies a ranking algorithm to the scores. For example, the training set generator 228 ranks the Tweets from high score, which may correspond to more and/or higher weighted keywords appearing in the Tweet, to low score, which may correspond to a fewer and/or lower weighted keywords appearing in the Tweet. The training set generator 228 then identifies “positive” documents to use as positive examples and “negative” documents to use as negative examples. In an exemplary implementation, documents associated with a score above a threshold are positive and documents below that threshold are negative. In another implementation, documents associated with a score above a threshold are positive and documents below a second, different threshold (e.g. bottom 5%) are negative. Such an implementation may result in easier cross-validation but may not be as good on unseen data, and the exemplary implementation, while slightly worse to cross-validate, may be better on unseen data, which may be preferred in some applications. In one implementation, the scoring uses term frequency multiplied by the inverse document frequency.

In one implementation, the training set generator 228 may down-sample the negative set when the positive and negative documents are unbalanced (e.g. the number of negative documents is (significantly) greater than the number of positive documents).

The training set generator 228 performs a feature selection on each document in the positive document set. Feature selection may be performed using various methods depending on the implementation. Examples of feature selection may include, but are not limited to inverse document frequency, bi-normal separation, etc. For example, the training set generator 228 calculates a score for every word. In one implementation, the feature selection produces a superset of the initial keywords and includes one or more words or phrases not in the initial keyword set. In one implementation, the feature selection may eliminate one or more words that are noisy from the initial keyword set. In one implementation, the training set generator 228 selects a portion of the features, e.g., the top 10,000 words, and represents each document as vector of the 10,000 words. In one implementation, the training set generator creates a vector space representation to represent the document in a highly dimensional vector space. For example, the training set generator 228, for each of the 10,000 words, multiplies the score associated with the word by the number of times the word is used in the document and divides by the number of words in the document. At this point, each document is associated with a bunch of vector values.

In one implementation, the training set generator 228 performs a feature selection on each document in the negative document set. The feature selection on each document in the negative document set may be similar to that described above with reference to the negative document set.

In one embodiment, when each document from both the positive and negative document sets is associated with a set of vector values, which serve as labels, this set of data is a training data set that is usable by a machine learning method. For example, the positive and negative document sets with associated vector value sets are labeled data that may be used as a training set by a classifier such as a support vector machine, decision tree, random forest, neural net, etc. for performing machine learning.

In some implementations, a classifier is trained by the machine learning system 120 using, as a training set, the training data (or a portion thereof) generated by the training data creator. In one implementation, the training data creator 104 may create new training data continuously or periodically and a classifier may be retrained using the new training data in addition to or instead of the earlier generated training data thereby updating the classifier and potentially making the classifier more accurate or maintaining accuracy of the classifier over time by reducing or eliminating the use of stale data in the creation of the classifier.

It should be recognized that Tweets are merely an example of unlabeled textual data and that other unlabeled textual data is contemplated and within the scope of this disclosure. For example, the unlabeled textual data may include, but is not limited to, one or more of e-mails, chat conversations, whitepapers, patents, business documents (e.g. contracts, purchase orders, etc.), system logs, service records, technical data, social media, news, websites, libraries, other repositories, etc.

It should be recognized that the training data may be used for machine learning for different use cases depending on the implementation. For example, the training data may be used to train a supervised learning model for searching or making recommendations, eDiscovery, Analytics, etc. For example, in the context of recommendation or search, the training set may be used to train a model for showing documents relevant to X, such as in response to a query, similar to another document, related to an interest or users like me. For example, in the context of eDiscovery, the training set may be used to train a model for showing documents relevant to this litigation or documents may be deleted. For example, in the context of analytics, the training set may be used to train a model for showing what X is thinking about Y or why Z made a certain decision.

It should further be recognized that, while training a single binary classifier is discussed above, the disclosure herein may be extended to a multiclass implementation. For example, in one implementation, multiple binary classifiers are trained. In another example, in one implementation, the training set generator 228 may perform multiple feature selections and train a multiclass classifier based on the union of the multiple feature sets resulting therefrom.

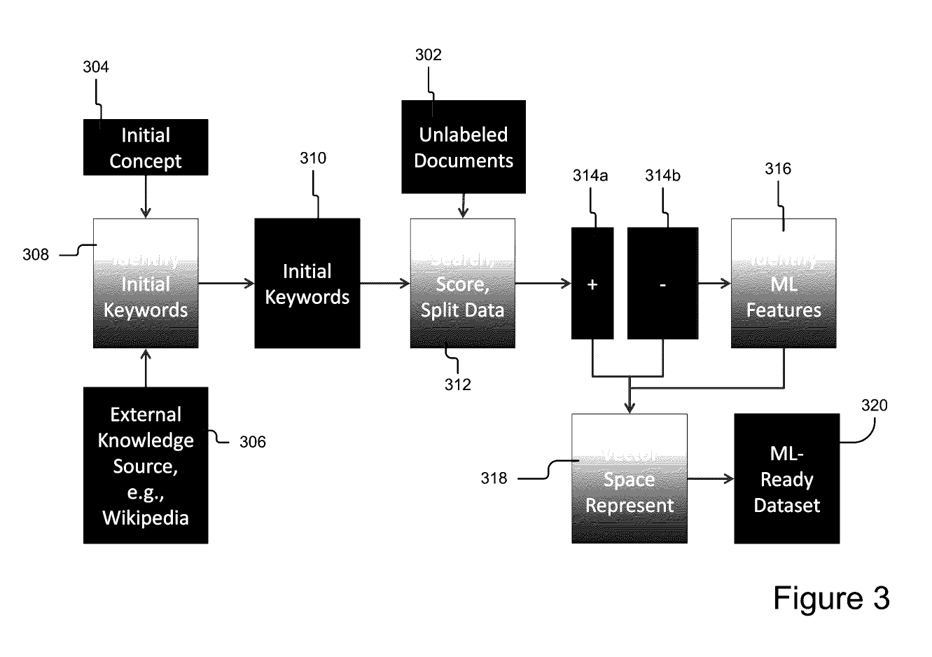

FIG. 3 is a flowchart of an example method 300 according to one implementation. The method 300 begins at block 302. At block 302, the data collection module 222 collects textual data in the form of unlabeled documents. At block 304, the initial concept receiver module 224 receives the initial concept. At block 306, the initial keyword generator module 226 determines and accesses a knowledge source. At block 308, the initial keyword generator module 226 identifies the initial keywords using the external knowledge source. At block 310, the initial keywords are passed to the training set generator 228. At block 312, the training set generator 228 obtains the unlabeled documents collected at block 302 and the initial keywords identified at block 310 and searches each unlabeled document using the initial keywords, scores each unlabeled document based on the search of the initial keywords and splits the data based on the score. For example, the training set data splits the documents into positive documents 314a and negative documents 314b. At block 316, the training set generator 228 selects features (i.e. identifies features for machine learning) from the positive and negative document sets. At block 318, the training set generator 228 uses the selected features and the positive and negative document sets to generate a vector space representation of each document. At block 320, the vector space representation of each document of the positive document set and the vector space representation of each document of the negative document set are ready for machine learning and may be passed, e.g., to the machine learning system 120.

It should be understood that while FIG. 3 includes a number of steps in a predefined order, the methods may not necessarily perform all of the steps or perform the steps in the same order. The method may be performed with any combination of the steps (including fewer or additional steps) different than that shown in FIG. 3, and the method may perform such combinations of steps in other orders.

In the above description, for purposes of explanation, numerous specific details are set forth in order to provide a thorough understanding of the present disclosure. It will be apparent, however, to one skilled in the art that the invention can be practiced without these specific details. In other instances, structures and devices are shown in block diagram form in order to avoid obscuring the description. For example, various implementations are described above with reference to particular hardware, software and user interfaces. However, the present disclosure applies to other types of implementations distributed in the cloud, over multiple machines, using multiple processors or cores, using virtual machines or integrated as a single machine.

Reference in the specification to “one implementation” or “an implementation” means that a particular feature, structure, or characteristic described in connection with the implementation is included in at least one implementation. The appearances of the phrase “in one implementation” in various places in the specification are not necessarily all referring to the same implementation. In particular the present disclosure is described above in the context of multiple distinct architectures and some of the components are operable in multiple architectures while others are not.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is described without reference to any particular programming language. It will be appreciated that a variety of programming languages may be used to implement the teachings of the invention as described herein.

The foregoing description of the implementations of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A method comprising:
obtaining, using one or more processors, a plurality of unlabeled text documents;
obtaining, using the one or more processors, an initial concept;
obtaining, using the one or more processors, keywords from a knowledge source based on the initial concept;
scoring, using the one or more processors, the plurality of unlabeled documents based at least in part on the initial keywords;
determining, using the one or more processors, a categorization of the documents based on the scores;
performing, using the one or more processors, a first feature selection and creating a first vector space representation of each document in a first category and a second category associated with the first feature selection, the first and second categories based on the scores, the first vector space representation serving as one or more labels for an associated unlabeled textual document; and
generating, using the one or more processors, the training set including a subset of the obtained unlabeled textual documents, the subset of the obtained unlabeled documents including a documents belonging to the first category based on the scores and documents belonging to the second category based on the scores, the training set including the first vector space representations for the subset of the obtained unlabeled documents belonging to the first category based on the scores and the second category based on the scores, the first vector space representations serving as one or more labels of the subset of the obtained unlabeled documents belonging to the first category and the second category.

2. The method of claim 1 comprising:
using the vector space representation of each document in the one or more categories as labels for the unlabeled textual documents; and
generating, using the vector space representation of each document in the first and second categories as labels for the unlabeled textual data, a model using a supervised machine learning method.

3. The method of claim 2, wherein the model using the supervised machine learning method is a classifier.

4. The method of claim 2, wherein generating the model using the supervised machine learning method includes training one or more binary classifiers.

5. The method of claim 1 comprising:
performing a second feature selection and creating a second vector space representation of each document in a third category and a fourth category associated with the second feature selection, the third and fourth categories based on the scores, the second vector space representation serving as one or more additional labels for an associated unlabeled textual document;
using the first and second vector space representations of each document in the one or more categories as labels for the unlabeled textual documents; and
generating, using the vector space representation of each document in the first, second, third and fourth categories as labels for the unlabeled textual data, a model using a multiclass classifier on a union of feature sets from the first and second feature selections.

6. The method of claim 1 comprising:
determining the knowledge source based on the initial concept.

7. The method of claim 1, wherein the categorization of documents based on score categorizes a document with a score satisfying a first threshold as positive and categorizes the document as negative when the score of the document does not satisfy the first threshold.

8. The method of claim 1, wherein the categorization of documents based on score categorizes a document with a score satisfying a first threshold as positive and categorizes the document as negative when the score of the document satisfies a second threshold.

9. The method of claim 1, wherein the scores are based in part on the knowledge source from which a first, initial keyword was obtained and based on weights associated with the initial key words.

10. A system comprising:
one or more processors; and
a memory including instructions that, when executed by the one or more processors, cause the system to:
obtain a plurality of unlabeled text documents;
obtain an initial concept;
obtain keywords from a knowledge source based on the initial concept;
score the plurality of unlabeled documents based at least in part on the initial keywords;
determine a categorization of the documents based on the scores;
perform a first feature selection and creating a first vector space representation of each document in a first category and a second category associated with the first feature selection, the first and second categories based on the scores, the first vector space representation serving as one or more labels for an associated unlabeled textual document; and
generate the training set including a subset of the obtained unlabeled textual documents, the subset of the obtained unlabeled documents including a documents belonging to the first category based on the scores and documents belonging to the second category based on the scores, the training set including the first vector space representations for the subset of the obtained unlabeled documents belonging to the first category based on the scores and the second category based on the scores, the first vector space representations serving as one or more labels of the subset of the obtained unlabeled documents belonging to the first category and the second category.

11. The system of claim 10, wherein the instructions, when executed by the one or more processors, further cause the system to:
use the vector space representation of each document in the one or more categories as labels for the unlabeled textual documents; and
generate, using the vector space representation of each document in the first and second categories as labels for the unlabeled textual data, a model using a supervised machine learning method.

12. The system of claim 11, wherein the model using the supervised machine learning method is a classifier.

13. The system of claim 11, wherein generating the model using the supervised machine learning method includes training one or more binary classifiers.

14. The system of claim 10, wherein the instructions, when executed by the one or more processors, further cause the system to:
perform a second feature selection and creating a second vector space representation of each document in a third category and a fourth category associated with the second feature selection, the third and fourth categories based on the scores, the second vector space representation serving as one or more additional labels for an associated unlabeled textual document;
use the first and second vector space representations of each document in the one or more categories as labels for the unlabeled textual documents; and
generate, using the vector space representation of each document in the first, second, third and fourth categories as labels for the unlabeled textual data, a model using a multiclass classifier on a union of feature sets from the first and second feature selections.

15. The system of claim 10, wherein the instructions, when executed by the one or more processors, further cause the system to
determine the knowledge source based on the initial concept.

16. The system of claim 10, wherein the categorization of documents based on score categorizes a document with a score satisfying a first threshold as positive and categorizes the document as negative when the score of the document does not satisfy the first threshold.

17. The system of claim 10, wherein the categorization of documents based on score categorizes a document with a score satisfying a first threshold as positive and categorizes the document as negative when the score of the document satisfies a second threshold.

18. The system of claim 10, wherein the scores are based in part on the knowledge source from which a first, initial keyword was obtained and based on weights associated with the initial key words.

19. A computer-program product comprising a non-transitory computer usable medium including a computer readable program, wherein the computer readable program, when executed on a computer, causes the computer to perform operations comprising:
obtaining a plurality of unlabeled text documents;
obtaining an initial concept;
obtaining keywords from a knowledge source based on the initial concept;
scoring the plurality of unlabeled documents based at least in part on the initial keywords;
determining a categorization of the documents based on the scores;
performing a first feature selection and creating a first vector space representation of each document in a first category and a second category associated with the first feature selection, the first and second categories based on the scores, the first vector space representation serving as one or more labels for an associated unlabeled textual document; and
generating the training set including a subset of the obtained unlabeled textual documents, the subset of the obtained unlabeled documents including a documents belonging to the first category based on the scores and documents belonging to the second category based on the scores, the training set including the first vector space representations for the subset of the obtained unlabeled documents belonging to the first category based on the scores and the second category based on the scores, the first vector space representations serving as one or more labels of the subset of the obtained unlabeled documents belonging to the first category and the second category.

20. The computer-program product of claim 19, wherein the computer readable program, when executed on a computer, causes the computer to perform operations comprising:
using the vector space representation of each document in the one or more categories as labels for the unlabeled textual documents; and
generating, using the vector space representation of each document in the first and second categories as labels for the unlabeled textual data, a model using a supervised machine learning method.
